(19) United States
(12) Patent Application Publication
(10) Pub. No.: US 2009/0271616 A1
(43) Pub. Date: Oct. 29, 2009

(54) Method for transferring encoded messages

(76) Inventors: Gernot Hofstädter, Innsbruck (AT); Richard Adolf Dittrich, Innsbruck (AT)

Correspondence Address: WENDEROTH, LIND & PONACK, L.L.P., 1030 15th Street, N.W.,, Suite 400 East, Washington, DC, 20005-1503, US

(21) Appl. No.: 12/457,157

(22) Filed: Jun. 2, 2009

Related U.S. Application Data
(63) Continuation of application No. PCT/AT2007/000540, filed on Nov. 30, 2007.

(30) Foreign Application Priority Data
Dec. 4, 2006 (AT) A2004/2006

(51) Int. Cl. H04L 29/06; H04L 12/22

(52) U.S. Cl. 713/153; 713/186

(57) ABSTRACT

Disclosed is a method for transferring encoded messages between at least two users, particularly cryptographic protocol, the message transaction taking place by inserting an authentication device which decodes the messages received from the users and sends especially encoded messages to the users. Said method comprises the following steps: a1) the user (A) sends a message (NAⱼ) to the authentication device (AE); a2) the authentication device (AE) creates a transaction identification record (TID); a3) the authentication device (AE) sends a message (NAEⱼ) containing the transaction identification record (TID) to the user (A); a4) the user (A) creates a message (NA_{z}) that is encoded by means of a key (SA_{z}) and contains the transaction identification record (TID); h) the message (NA_{z}) is sent to a second user (B); i) the second user (B) creates a message (NBⱼ) that includes the encoded message (NA_{z}) and is encoded by means of another key (SB); j) the message (NBⱼ) is sent to the authentication device (AE); k) the authentication device (AE) decodes the message (NBⱼ), (NA_{z}) with the help of the respective key (SBⱼ), (SA_{z}), I) the authentication device (AE) creates a message (NAE_{z}) by referring to the plain texts (A_{z}), (Bj) contained in the decoded messages (NA_{z}), (NBⱼ); and m) the message (NAE_{z}) is sent to the first user (A) and/or the second user (B).

The invention concerns a method of transferring encrypted messages between at least two users, in particular a cryptographic protocol, wherein the transaction of the messages takes place with the interposition of an authentication device which decrypts the messages received from the users and in turn sends in particular encrypted messages to the users.

Methods of transferring encrypted messages have long been known, wherein the security of what are referred to as cryptographic methods are based on the complexity of the transformations used and secrecy of the keys. Essential aims of modern cryptography are firstly that only authorised persons should be in a position to read the data or message or to obtain information about the content thereof, secondly the author of the data or the sender of the message should be uniquely identifiable and not in a position to dispute his authorship and thirdly it should be ensured that the data after production thereof were not modified without authority.

All of the cryptographic methods which ensure secure transport of a message from the sender to the recipient by means of encryption are referred to as a cryptosystem which considered mathematically comprises a message, a secret text, the key and functions for enciphering and deciphering. In that respect the security of a cryptosystem generally depends on the size of the key space and the quality of the enciphering function.

In principle the cryptosystems used can be divided into symmetric, asymmetric and hybrid cryptosystems. Symmetric cryptosystems are distinguished in that the enciphering key and the deciphering key are the same or can be at least easily derived from each other while with asymmetric cryptosystems the algorithms used are so selected that there is not a trivial relationship between an enciphering key and the associated deciphering key so that it is not possible to directly infer the deciphering key from the enciphering key. Hybrid cryptosystems seek to combine the advantages of the symmetric and asymmetric systems, in which respect message exchange generally takes place by means of a fast symmetric method while an asymmetric method is used for exchange of the session key.

Symmetric cryptosystems suffer from the problem of key distribution which is that of making a common private key accessible to the communication partners.

The key distribution problem does not exist with asymmetric encryption systems based on what is referred to as public key encryption. In that respect the principle of the private key is turned completely on its head as anyone knows or has the public key. However only one person can read the message with the associated private key. In other words the sender encrypts with the public key of the recipient which can be known to everyone. The recipient thereafter decrypts with his secret private key.

However secure public key encryption may be there are nonetheless weaknesses in confidential information exchange. As the public key is known to everyone it is possible for encrypted messages also to be sent under a false name. The procedure therefore lacks a correct signature which identifies the writer or confirms the authenticity of the document. For that reason with asymmetric cryptosystems it is necessary for the sender with his private key to produce a signature which he attaches to the document. That signature can be checked by the recipient with the public key and thus the authenticity of the sender can be verified.

The procedure involved in data transfer generally takes place in accordance with a protocol which represents a unique and unequivocal handling instruction to the participants. So that it can be used in meaningful manner, a protocol must be executable, that is to say when all participants keep to the specification the desired result must be achieved. Furthermore the protocol should guarantee correctness, that is to say if a subscriber attempts to cheat or deceive there must be a high level of probability that that attempt will be detected.

A frequently used protocol in the area of cryptography in which two communication partners produce a secret key which is known only to those two is represented by the so-called Diffie-Hellmann key exchange. The key generated using that principle is usually employed to transmit encrypted messages by means of a symmetric cryptosystem. The Diffie-Hellmann key exchange is based on the consideration that something is easy to do in the one direction but can only be done with very great difficulty in the opposite direction. Expressed mathematically the Diffie-Hellmann key exchange is therefore based on a one-way function, wherein the problem is only to be resolved with an enormous amount of computing effort, whereby an attacker, even with knowledge of the individual messages transmitted in unencrypted form, is not in a position to compute the generated key. It will be noted however that the Diffie-Hellmann key exchange is no longer secure when an attacker succeeds in modifying the data packets in the case of what is referred to as a man-in-the-middle attack.

In practice this means that the attacker intercepts the messages sent by A and B and forwards his own messages in each case. That is to say, in principle a Diffie-Hellmann key exchange is carried out twice, and more specifically once between the user A and the attacker and once between the attacker and user B. As the users A and B assume that they are each communicating with the respective other user the attacker, while diverting the messages by way of himself, can bug the symmetrically encrypted communication and in so doing both read and also unobservedly modify the message content. To exclude such a man-in-the-middle attack the exchanged messages must additionally be authenticated, which can be effected for example by means of electronic signatures.

A further known protocol for secure data exchange in a decentral network is the Needham-Schroeder protocol which combines key exchange and authentication with the aim of establishing a secure communication between two partners in a decentral network. The basis for the security of that protocol is secure encryption algorithms with any desired keys which cannot be broken either by cryptoanalysis or by exhaustive search, while both symmetric and asymmetric methods can be used.

In the symmetric variant of the Needham-Schroeder protocol it is presupposed that both A and also B each have a secret key with what is referred to as an authentication server. So that now A can carry out a secure data exchange with B, in a first step A sends a message to the authentication server which subsequently twice introduces the session key into the answer sent back to A, more specifically encrypted once with the secret key of A and once with the secret key of B. In a further sequence A sends the session key encrypted with the secret key of B to B so that ultimately both A and B are in possession of the session key assigned by the authentication server.

The problem with the previously known cryptosystems therefore lies in the direct message transmission between the two users. Admittedly those messages are encrypted, but if an attacker succeeds in acquiring possession either of the secret common key in the case of symmetric methods or the private key in the case of asymmetric methods the attacker is in a position to read the transferred messages.

Therefore the object of the invention is to provide a novel method of transferring encrypted messages between at least two users, with which the above-described disadvantages can be avoided.

The method according to the invention attains that object by the following steps:

a) production of a message encrypted with a first key by a first user,

b) sending of that message to a second user,

c) production of a second message containing the encrypted first message and encrypted with a further key by the second user,

d) sending of the second message to the authentication device,

e) decryption of the second and the first message using the corresponding keys by the authentication device,

f) production of a third message by the authentication device with reference to the clear texts contained in the decrypted messages, and

g) sending of the third message to the first user and/or the second user.

In other words in accordance with the invention no key exchange but only key forwarding takes place between the two users so that neither of the two users has the possibility or the capability of decrypting encrypted messages of the respective other user and reading them.

In accordance with a preferred embodiment of the invention it is provided that the encrypted message produced by the first user includes a transaction identification data set, preferably a transaction identification number, wherein the exchange of items of transaction information is limited to the direct connection between the user and the authentication device.

This means that decryption of the data can be effected only by the authentication device, wherein in accordance with a further embodiment of the invention the authentication device produces the transaction identification data set and sends a message containing the transaction identification data set to the user who integrates that contained transaction identification data set into the encrypted message to be sent thereby to the second user.

In accordance with a further embodiment of the invention it is provided that the authentication device has an authentication server and a data server, wherein the authentication server produces a database entry which is or can be associated with the message sent by the first user to the authentication device on the database server, wherein desirably the transaction identification data set is or can be uniquely associated with the database entry.

The production of a database entry on a database server and the association of a transaction identification data set with the produced database entry makes it possible for the authentication device to associate the encrypted messages received by the users with each other after decryption. For that purpose it has further proven to be advantageous if the message transferred by the authentication device to the first user, besides the transaction identification data set, contains further, preferably dynamic items of transaction information.

Although it is not necessary to encrypt the request communicated by the first user to the authentication device and the answer containing the transaction identification data set as a possible attacker, on the basis of the items of information contained therein, is not in a position to draw conclusions about the keys later used by the users, it can be provided in accordance with a further embodiment of the invention that the message from the first user to the authentication device and/or the message from the authentication device to the first user is/are at least partially encrypted prior to the transfer.

In contrast to the Needham-Schroeder protocol, the method according to the invention provides that static identifications of the respective opposite party are neither known to a user nor are they exchanged between the users. The items of transaction information are only forwarded by the authentication device to the first user, by same to the second user and by the second user to the authentication device, wherein each of the users adds his own items of information to the received encrypted items of information, encrypts the overall packet and forwards that encrypted overall packet to the next user who proceeds in the same fashion.

In other words the actual exchange of items of transaction information is limited to the direct connection of the user to the authentication device so that decryption of the data can be implemented only by the authentication device. That novel principle of data transmission which is encrypted ‘in itself’ allows a secure development of the data transfer between two users in a network irrespective of whether this involves the Internet, an intranet, an xtranet, a WAN or a LAN or similar connecting procedures between two users who wish to transfer secured data.

In accordance with a further embodiment of the invention it is provided that the authentication device decrypts the received messages using the corresponding keys and compares, co-ordinates or combines the clear texts contained in the decrypted messages before producing a message referring to the result of the clear text comparison, co-ordination and combination.

The fact that decryption, comparison, co-ordination and combination are effected exclusively by the authentication device means that the method according to the invention attains a level of security in data transfers in networks, that is increased in comparison with the state of the art.

In that respect a further embodiment of the invention provides that after comparison, co-ordination or combination of the clear texts contained in the decrypted messages, the authentication device sets an action referring to the result of comparison, co-ordination or combination and thereafter produces a message referring to the set action.

In addition it is certainly possible to communicate to the users the same message but encrypted with different keys, about the set action. In accordance with a further embodiment however enhanced security can be achieved if the authentication device produces a message intended for the first user and a message intended for the second user and sends same to the respective users so that an attacker who is in possession of the common secret key between the authentication device and a user can only read the information intended for that user, but on the basis of that information cannot draw any conclusions about the data transferred between the two users.

Although the basic principle of the novel method is not limited to a specific mode of transfer, a preferred embodiment of the invention provides that the transfer of the messages is effected by way of a network, preferably by way of the Internet.

As is known per se from cryptosystems, in that case at least one of the encrypted messages contains a clear text and a transaction identification data set and preferably also encrypted, preferably dynamic items of transaction information.

To prevent a possible attacker being able to easily read the transferred data, an embodiment of the invention provides that at least one user has at least one secret key with the authentication device, in which respect it has proven to be advantageous if each user respectively has at least one secret key with the authentication device. If that is the case it has proven to be advantageous if the messages are transferred in accordance with a symmetric cryptographic protocol.

The method according to the invention therefore provides a method, the use of which leads to an absolutely secure cryptosystem, in other words at no time do the transferred data contain sufficient items of information to be able to derive clear text or keys therefrom. Accordingly, besides the hitherto sole cryptosystem deemed to be secure, referred to as the one-time pad, the method according to the invention affords a second absolutely secure cryptosystem which ideally fulfils the Kerckhoffs' principle whereby the security of a cryptosystem may not depend on the secrecy of the algorithm but is only based on secrecy of the key.

In order to be able to fulfil the fundamental prerequisites for ensuring security of the method according to the invention which are that the one-time key must remain secret, must be unpredictably random and may be used only once, a further embodiment of the invention provides that the key or keys between the user or users and the authentication device is/are distributed by means of a mobile data carrier on which the key is stored and/or which is adapted to generate the key, wherein a respective dedicated data carrier is or can be associated with each user. In that case the mobile data carrier associated with a user is adapted to generate a plurality of preferably one-time keys, wherein the respective user has all keys generated by the data carrier associated with him jointly with the authentication device.

The method according to the invention can be used for example for guaranteeing compensations for services provided and deliveries of goods, referred to as a clearing process, and in that respect uses tried-and-tested encryption methods which are already in common use. In the example described hereinafter the contract between supplier and customer is concluded outside the control of the novel method, for which reason that step is not described in greater detail herein.

The clearing process can be structured substantially in four sub-steps, namely a first step in which the supplier makes a demand in relation to a customer at the authentication device, specifying the settlement terms. That demand includes the crucial elements of the demand for compensation as a supply in units. In that second step the customer acknowledges the demand in regard to the delivery of the units at a specific moment in time which however can immediately be a definite date in the future. In the third step the authentication device then confirms matching of the demand and blocks the units for the transfer until the agreed moment in time, whereupon in the fourth step implementation or clearing of the demand takes place at the agreed moment in time.

Besides the method according to the invention the invention further seeks to provide an encryption device in hardware terms, which is suitable in particular for use in the method according to the invention.

Unlike the previously known encryption devices in hardware terms, for example a smart card, the encryption device according to the invention is in a position to implement specific algorithms so that the key which for each respective user comprises a base key supplemented with a dynamic key is freshly generated for each encryption operation and in that way is one-time. For that purpose the invention provides that the hardware encryption device is formed by a mobile data carrier which has a memory unit, a computing unit for generating at least one preferably one-time key and an interface, preferably a USB interface.

To prevent prohibited use of the encryption device it can further be provided that it has a biometric access control device, wherein a preferred embodiment of the invention provides that the biometric access control device has a sensor for recognising a fingerprint.

Besides use of the biometric access control device for verifying the user of the encryption device it would also be conceivable for the biometric feature of the user verified by the biometric access control device to be used for generating the key.

A further aspect of the invention lies in the use of a USB stick, preferably with a fingerprint recognition function, as an encryption device in cryptography.

Further advantages and details of the invention will be described more fully by means of the specific description hereinafter with reference to the embodiments by way of example illustrated in the drawing in which:

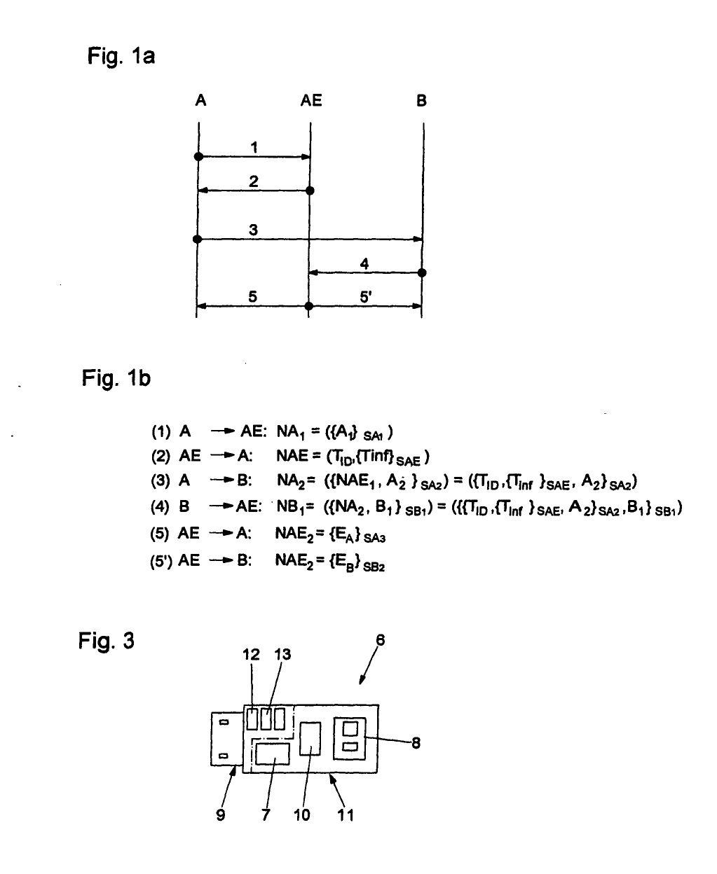

FIGS. 1a and 1b show the principle of the method steps of a first embodiment by way of example of the invention,

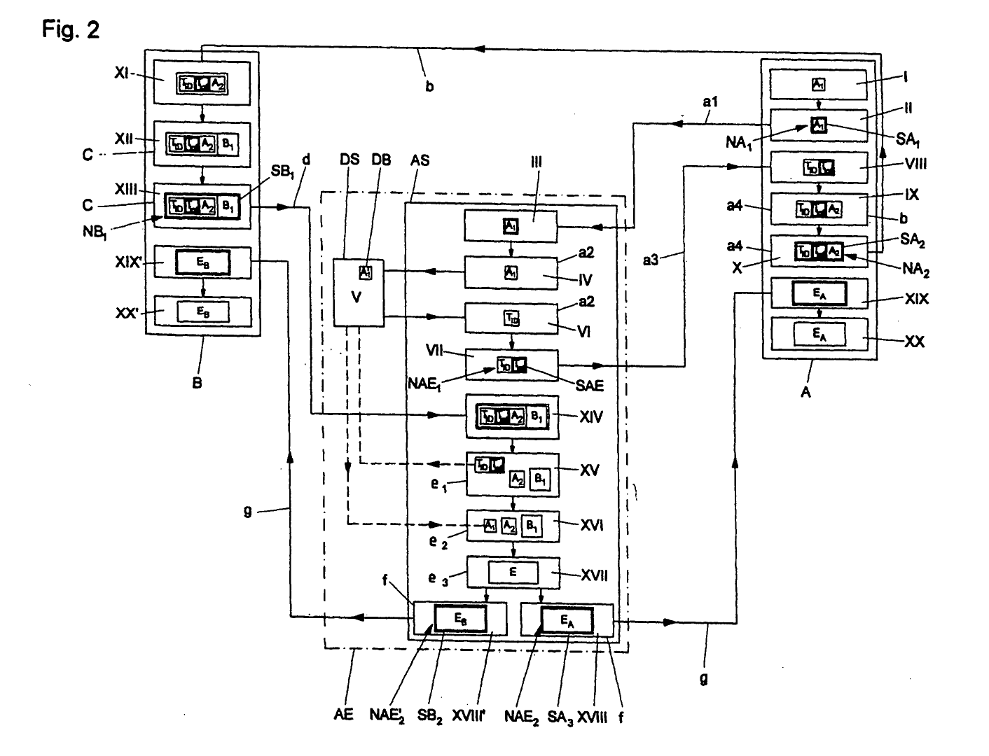

FIG. 2 shows the procedure involved in the embodiment of FIG. 1 in detail, and

FIG. 3 shows a diagrammatic view showing the principle of an encryption device according to the invention.

Referring to FIGS. 1a and 1b the basic principle of the encrypted data transfer is described hereinafter, on the basis that the static identifications of the users A, B are neither known to the respective other user nor are transmitted directly between the two users A and B. In the described embodiment all messages are transferred in encrypted form.

The data transfer is initiated by the user A who in step 1 sends a message NA₁ which includes clear text A₁ encrypted with the key SA₁, to the authentication device AE. As an answer, the user A in step 2 receives from the authentication device AE a message NAE₁ which includes a transaction identification data set T_{ID} and items of transaction information T_{INF} encrypted with the key SAE. In a further succession the user A supplements the received message NAE₁ with his own items of information A₂ relating to the transaction and encrypts the overall packet with the key SA₂ and in that way produces a message NA₂. He sends that message NA₂ to the user B in step 3.

The user B in turn supplements the received message NA₂ with his own items of information B₁ relating to the transaction, encrypts the overall packet with his key SB₁ and in that way produces the message NB₁ which he then sends to the authentication device AE in step 4.

The authentication device AE decrypts the received messages, compares the contained items of information which were also transferred independently by the user A and the user B, that is to say the authentication device AE thus effects what is referred to as matching, and, on the basis of the matching result for the user A, produces a message NAE₂ which contains a clear text E_{A} encrypted with the key SA₃ and for the user B a message NAE₂′ which contains a clear text E_{B} encrypted with the key SB₂ and sends those two messages to the respective users A and B in steps 5 and 5′.

Data security and data protection in respect of the communicated messages are ensured by way of per se known encryption methods. If the currently used RSA methods should no longer suffice or if more recent technologies with which the level of security can be increased become known, renewal or adaptation of the procedures and algorithms is possible in relation to the applicants without replacement of any hardware.

The contents of the messages which have to be exchanged during a transaction are verified by a reliable check sum mechanism. For that purpose the method according to the invention uses a SHA (secure hash algorithm) with the collision probability of about 1/10⁸⁰. In addition each data file which is exchanged during a transfer operation is signed by the respective sender.

It is essential in that respect that the actual information of the data transfer is never exchanged directly between the two users A and B. This means that the actual information always flows by way of the authentication device which compares the information and confirms the result of the comparison to the two users A, B. It follows therefrom that the users A, B have neither the possibility nor the capability of decrypting the information of the respective other user A, B as in fact no key exchange takes place between the users A, B, but only an encrypted key forwarding.

The actual communication in message transfer is based on XML data exchange over TCP/IP, wherein the communication is conducted between the users by way of what is referred to as a quired secure channel, for example HTTPS.

The certainty that the keys which the users have in common with the authentication device are actually secret and one-time is guaranteed by way of the encryption device in hardware terms, which will be described in greater detail hereinafter. That encryption device can be made available for example to the two users A, B by the operator of the authentication device. In addition it should be ensured that the hardware encryption device of a user does not have a direct communication link to the network of the respective other user.

FIG. 3 is a diagrammatic view showing the principle of the hardware encryption device 6 designed for the method according to the invention. With the encryption device 6, the user A, B produces the message to be communicated, by putting the items of information necessary for the data transfer into an in-buffer 12, whereupon he receives the encrypted result in the out-buffer 13. It is important in that respect that the user of the encryption device 6 does not have any access to data and processes which take place in the encryption device 6. Thus for example it can be provided as a further security feature that any attempt at intervention in or access to the protected region 11 which is to the right of the dash-dotted line in FIG. 3 results in the destruction of all information.

Besides the protected region 11 the encryption device 6 has an interface 9 which is in the form of a USB interface in the illustrated embodiment. Disposed within the protected region 11 are a memory unit 7, a processor 8 and a biometric access control device 10. The encryption device 6 is in a position to implement specific algorithms by way of software stored in the memory unit 7 and to produce by means of the processor 8 the numbers necessary for the encryption procedure.

The encryption device 6 appears as a removable data carrier in the connected system which for example is formed by a PC, wherein the in-buffer 12 and the out-buffer 13 arranged in the interface 9 of the encryption device 6 are visible as data folders. Exchange of data with the encryption device 6 is ensured by way of data exchange to the corresponding folders. Thus the items of information necessary for the data transfer are filled in MXL data files which are copied for encryption to the in-buffer 12.

In addition the encryption device 6 may also have a simple update mechanism which makes it possible to insert new or altered software and in that way to re-compute the keys or compute new keys.

To obviate misuse of the encryption device 6 the fingerprint which is specific to the respective user is stored on the encryption device 6 and is available only in encrypted form. As part of the sent messages the fingerprint is added in each encryption and checked in each decryption.

Disposed in the protected region 11 of the encryption device 6 is the software necessary for encryption, computation of the HASH and identification of the fingerprint. Enablement of the protected region 11 is effected by way of a request-replay mechanism which is called up by the respective user A, B. Linked thereto can be the input of a personal PIN, by which the software can first come into operation. That mechanism is independent of the I/O function of the encryption device 6 itself.

Also disposed in that protected region 11 are the necessary keys for secure data transfer and the activation mechanism for the encryption programs, which mechanism can run for example as a PIN check.

The general format of the messages which are produced with the encryption device 6 is formed from a user ID, the text string of the information, a check sum about the information and the signature of the user, wherein the communication between the users A, B and the authentication device AE is based generally on web services, for example SOAP.

The information is exchanged by way of XML formats and can be interpreted equally thus for the users. Communication of the items of information is effected in messages in the form of data packets which are respectively provided with a hash key and the fingerprint representing the signature. In that case message exchange takes place in encrypted form between the users.

A message transfer in accordance with the invention is described hereinafter with reference to FIG. 2.

In step 1 the user A produces the clear text A₁ which he encrypts in step II with the key SA₁ and in that way produces the message NA₁. Production of the message NA₁ is effected as described hereinbefore by means of the encryption device 6 by his writing the necessary information into the input buffer/in-buffer 12 of the encryption device 6. As a result he receives the encrypted message NA₁. In accordance with method step a1) the user A then sends the encrypted message NA₁ to the authentication device AE, for example by way of a transaction start request.

The authentication server AS of the authentication device AE receives the message NA₁ in step III, decrypts it in accordance with step IV and begins the transaction sequence by the authentication server AS producing a new database entry DB on the data server DS of the authentication device AE (step V) and at the same time in step VI generates a transaction identification data set T_{ID} which is unique to that transaction and which can be uniquely associated with the database entry DB (in accordance with method step a2)).

In step VII the authentication server AS generates a message NAE₁ which, besides the transaction identification data set T_{ID}, contains further items of transaction information T_{inf} encrypted with the key SAE.

In accordance with method step a3) the user A acquires that message NAE₁ in step VIII, wherein the encrypted transaction information T_{inf} is not readable for the user A. In step IX the user A supplements the received message in NAE₁ with his own data A₂ for the transaction and encrypts that overall packet in accordance with step X with the key SA₂ and in that way produces the message NA₂. In accordance with method step b) the user A communicates the message NA₂ to the user B who receives that message in accordance with step XI.

The user B admittedly also has an encryption device 6 as each encryption device 6 is however in itself one-time, it is not possible for the user B to decrypt the message NA₂ received from the user A, with his encryption device 6.

Similarly to step IX, the user B in accordance with step XII supplements the acquired message NA₂ with his own items of information B₁ relating to the transaction and forwards the overall packet to his encryption device 6. As a result in step XIII the user B receives a message NB₁ encrypted with the key SB₁ (method step c)).

In a further succession the user B in accordance with method step d) communicates the message NB, to the authentication server AS by means of a transaction confirmation. In accordance with step XIV the authentication server AS receives the message NB, and, by virtue of the application of the keys SA, SB which the authentication device AE has jointly with the users A, B, is in a position to stepwise decrypt the received message NB₁.

In a further succession it is possible for the authentication server AS in accordance with method steps e1) and e2) in conjunction with the data server DS to compare together the items of information which were also provided during the data transfer independently by the users A, B and thus to effect what is referred to as matching (step XVI).

In the illustrated embodiment the authentication server AS, after matching in accordance with method step e3), sets an action E referring to the result of the matching operation (step XVII).

In accordance with method step f in further succession the authentication server AS produces in the steps XVIII, XVIII′ a message NAE₂ referring to the set action E for the user A and a message NAE₂′ for the user B.

In conjunction with the data server DS the authentication server now uses the reverse method and in accordance with method step g gives back to the user A and the user B in encrypted form respective individual transaction confirmations which are decrypted by the respective users A, B with the respective keys in accordance with step XX, XX′.

It will be appreciated that the described embodiment by way of example of a method of transferring encrypted messages between at least two users and the illustrated embodiment of an encryption device are not to be interpreted in a restrictive sense but are only individual examples of numerous possible ways of implementing the concept of the invention.

Thus it would also be conceivable for example that only one of the two users has a secret common key with the authentication device while the second user uses public key encryption with the authentication device. At any event what is essential to the invention is the fact that no static identification data are exchanged between the two users, that is to say the method according to the invention provides that there is no key exchange between the two users but only encrypted key forwarding, wherein each subscriber in a transaction additionally encrypts the acquired encrypted data packets with his own key and forwards same and only the authentication device is in a position to stepwise decrypt the data packet.

1. A method of transferring encrypted messages between at least two users, in particular a cryptographic protocol, wherein the transaction of the messages takes place with the interposition of an authentication device which decrypts the messages received from the users and in turn sends in particular encrypted messages to the users, and includes the following steps:
a1) sending of a message (NA₁) by the user (A) to the authentication device (AE),
a2) production of a transaction identification data set (T_{ID}) by the authentication device (AE),
a3) sending of a message (NAE₁) containing the transaction identification data set (T_{ID}) by the authentication device (AE) to the user (A),
a4) production of a message (NA₂) encrypted with a key (SA₂) and containing the transaction identification data set (T_{ID}) by the user (A);
b) sending of the message (NA₂) to a second user (B),
c) production of a message (NB₁) containing the encrypted message (NA₂) and encrypted with a further key (SB) by the second user (B),
d) sending of the message (NB₁) to the authentication device (AE),
e) decryption of the message (NB₁), (NA₂) using the corresponding keys (SB₁), (SA₂) by the authentication device (AE),
f) production of a message (NAE₂) by the authentication device (AE) with reference to the clear texts (A₂), (B₁) contained in the decrypted messages (NA₂), (NB₁), and
g) sending of the message (NAE₂) to the first user (A) or the second user (B).

2. A method as set forth in claim 1 wherein the encrypted message (NA₂) produced by the first user (A) includes a transaction identification data set (T_{ID}), preferably a transaction identification number.

3. A method as set forth in claim 2 wherein the message (NAE₁) transferred by the authentication device (AE) to the user (A) besides the transaction identification data set (T_{ID}) includes items of transaction information (T_{inf}) which are encrypted with a key (SAE) and which are preferably dynamic.

4. A method as set forth in claim 2 wherein the message (NA₁) from the first user (A) to the authentication device (AE) and/or the message (NAE₁) from the authentication device (AE) to the user (A) is/are at least partially encrypted prior to the transfer.

5. A method as set forth in claim 2 wherein the authentication device (AE) has an authentication server (AS) and a data server (DS), wherein the authentication server (AS) produces a database entry (DB) which is or can be associated with the message (NA₁) sent by the first user (A) to the authentication device (AE) on the database server.

6. A method as set forth in claim 5 wherein the transaction identification data set (T_{ID}) is or can be uniquely associated with the database entry (DB).

7. A method as set forth in claim 1 characterised by the steps:
e1) decryption of the messages (NB₁), (NA₂) using the corresponding keys (SB₁), (SA₂) by the authentication device (AE),
e2) comparison, co-ordination or combination of the clear texts (A₂), B₁) contained in the decrypted messages (NA₂), (NB₁), and
f) production of a message (NAE₂) referring to the result of comparison, co-ordination or combination of the clear texts (A₂), (B₁) by the authentication device (AE).

8. A method as set forth in claim 1 characterised by the steps:
e1) decryption of the messages (NB₁), (NA₂) using the corresponding keys (SB₁), (SA₂) by the authentication device (AE),
e2) comparison, co-ordination or combination of the clear texts (A₂), B₁) contained in the decrypted messages (NA₂), (NB₁),
e3) setting of an action (E) referring to the result of the comparison, co-ordination or combination, and
f) production of a message (NAE₂) referring to the set action (E), by the authentication device (AE).

9. A method as set forth in claim 1 characterised by the steps:
f) production of a message (NAE₂) intended for the first user (A) and a message (NAE₂′) intended for the second user (B) by the authentication device (AE) with reference to clear texts (A₂), (B₁) contained in the received and decrypted messages (NA₂), (NB₁), and
g) sending of the message (NAE₂) to the first user (A) and the message (NAE₂′) to the second user (B).

10. A method as set forth in claim 1 wherein the message or messages (NAE₂), (NAE₂′) are encrypted prior to sending by the authentication device (AE) with the keys (SB₂), (SA₃) associated with the respective users (A, B).

11. A method as set forth in claim 1 wherein the transfer of the messages (NA₁, NA₂, NB₁, NAE₁, NAE₂, NAE₂′) is effected by way of a network, preferably by way of the Internet.

12. A method as set forth in claim 1 wherein at least one of the encrypted messages (NA₂), (NB₁), (NA₂) contains a clear text (A), (B) and a transaction identification data set (T_{ID}).

13. A method as set forth in claim 12 wherein at least one of the encrypted messages (NA₂), (NB₁), (NA₂) further contains encrypted, preferably dynamic items of transaction information (T_{inf}).

14. A method as set forth in claim 1 wherein at least one user (A, B) has at least one secret key (SA, SB) with the authentication device (AE).

15. A method as set forth in claim 14 wherein each user (A, B) respectively has at least one secret key (SA, SB) with the authentication device (AE).

16. A method as set forth in claim 15 wherein the messages (NA₁), (NA₂), (NB₁), (NAE₁), (NAE₂), (NAE₂′) are transferred in accordance with a symmetric cryptographic protocol.

17. A method as set forth in claim 14 wherein the key or keys (SA, SB) between the user or users (A, B) and the authentication device (AE) is/are distributed by means of a mobile data carrier (6) on which the key (SA, SB) is stored and/or which is adapted to generate the key (SA, SB), wherein a respective dedicated data carrier is or can be associated with each user (A, B).

18. A method as set forth in claim 17 wherein the mobile data carrier (6) associated with a user (A) is adapted to generate a plurality of preferably one-time keys (SA₁, SA₂), wherein the respective user (A) has all keys (SA₁), (SA₂) generated by the data carrier (6) associated with him jointly with the authentication device (AE).

19. A hardware encryption device, in particular for use in a method as set forth in claim 1, wherein the encryption device is formed by a mobile data carrier (6) which has a memory unit (7), a computing unit (8) for generating at least one preferably one-time key (SA, SB) and an interface (9), preferably a USB interface.

20. An encryption device as set forth in claim 19 wherein it has a biometric access control device (10).

21. An encryption device as set forth in claim 20 wherein the biometric access control device (10) has a sensor for recognising a fingerprint.

22. Use of a USB stick as an encryption device in cryptography, in particular in a method as set forth in claim 1.

23. A USB stick as set forth in claim 22 wherein the USB stick has a fingerprint recognition function.
